(19) United States
(12) Patent Application Publication
(10) Pub. No.: US 2012/0069568 A1
(43) Pub. Date: Mar. 22, 2012

(54) Lighting module and corresponding method

(75) Inventors: Francesco Bianco, Spinea (Venezia) (IT); Alessandro Bizzotto, Castelfranco Veneto (Treviso) (IT); Alessandro Scordino, Dolo (Venezia) (IT); Peter Sachsenweger, Zeitlarn (DE)

(73) Assignee: OSRAM GESELLSCHAFT MIT BESCHRAENKTER HAFTUNG, Muenchen (DE)

(21) Appl. No.: 13/126,820

(22) PCT Filed: Oct. 28, 2009
(86) PCT No.: PCT/EP09/64223

§ 371 Date: Nov. 15, 2011

(30) Foreign Application Priority Data
Oct. 31, 2008 (EP) 08168028.2

(51) Int. Cl. F21V 13/04; B23P 11/00

(52) U.S. Cl. 362/243; 29/428

(57) ABSTRACT

A lighting module may include a printed circuit board carrying at least one light source, a reflector body to direct light from said at least one light source towards a distal opening of said reflector body, said reflector body having a bottom portion with first snap-in coupling formations coupling said printed circuit board to the bottom portion of said reflector body, and an optical holder carrying at least one lens to focus light from said at least one light source, said optical holder having second snap-in coupling formations coupling said optical holder to the bottom portion of said reflector body.

### FIELD OF THE INVENTION

This disclosure relates to lighting modules.

This disclosure was devised with specific attention paid to its possible application to high power LED lighting modules for, e.g., street lighting appliances.

### DESCRIPTION OF THE RELATED ART

LED-based streetlight sources typically include a large number of LED light sources mounted on fixed structures and arranged in plane matrixes. When resorting to these arrangements, the different systems (electronic, optic and thermal) are not integrated. This renders e.g. any kind of replacement difficult, which is in contrast to an easy access to LED light sources.

### OBJECT AND SUMMARY OF THE INVENTION

The need is therefore felt for integrated “light engine” assemblies including high power LEDs which are easy to handle, to install and to access in case any components need to be replaced. The need is also felt for light engines that are flexible in terms of placement for any possible application, including multiple arrays.

The object of the invention is to provide a response to these needs.

According to the present invention, that object is achieved by means of a lighting module having the features set forth in the claims that follow.

The invention also relates to a corresponding method.

The claims are an integral part of the disclosure of the invention provided herein.

An embodiment of the lighting module described herein provides a stable and smart mounting structure for a high power LED light engine where optical and electronic functions are integrated without the need of any additional fixing device, tool or mounting phase (e.g. applying screws).

An embodiment of the arrangement described herein provides a mounting structure permitting easy and fast assembly of the structure as well as adequate handling of the light engine, including replacement of parts.

Embodiments of the arrangement described herein:
do not require additional fixing elements and devices;
are compact, even in the case of a multi-functional fixing structure; and
are simple to manufacture and assure an adequate level of quality.

### BRIEF DESCRIPTION OF THE ANNEXED REPRESENTATIONS

The invention will now be described, by way of example only, with reference to the enclosed representations, wherein:

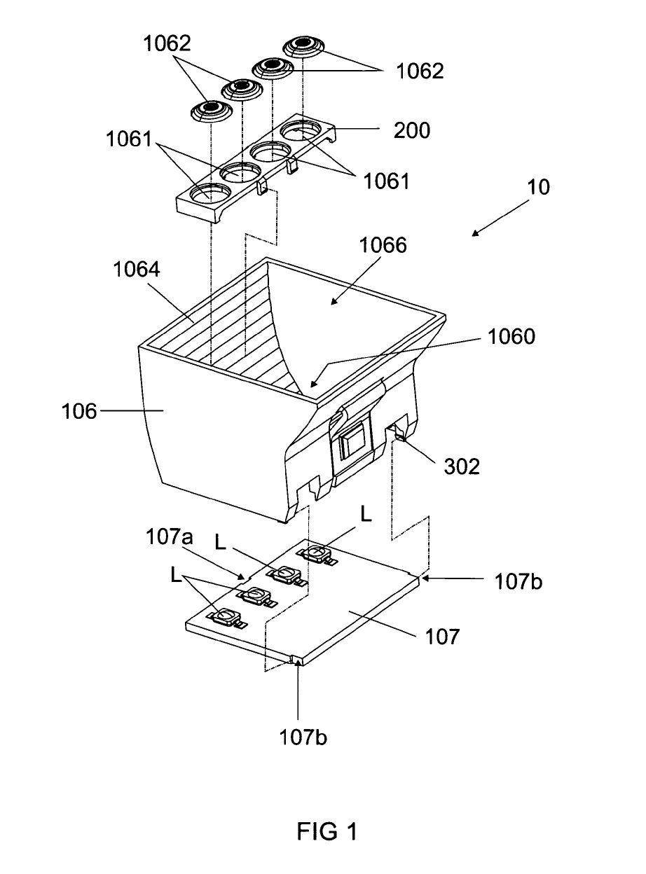

FIG. 1 is a general exploded view of a lighting module as described herein;

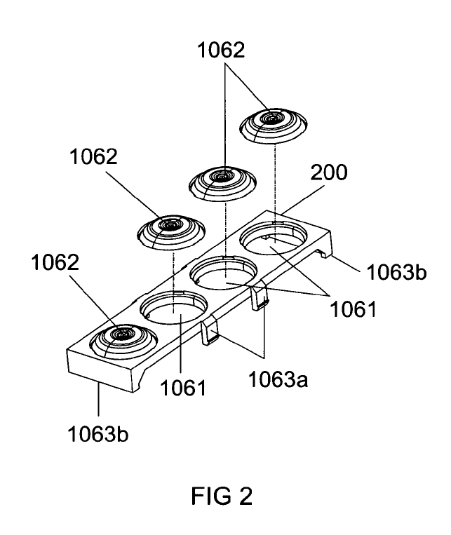

FIG. 2 details certain parts of the embodiment of FIG. 1;

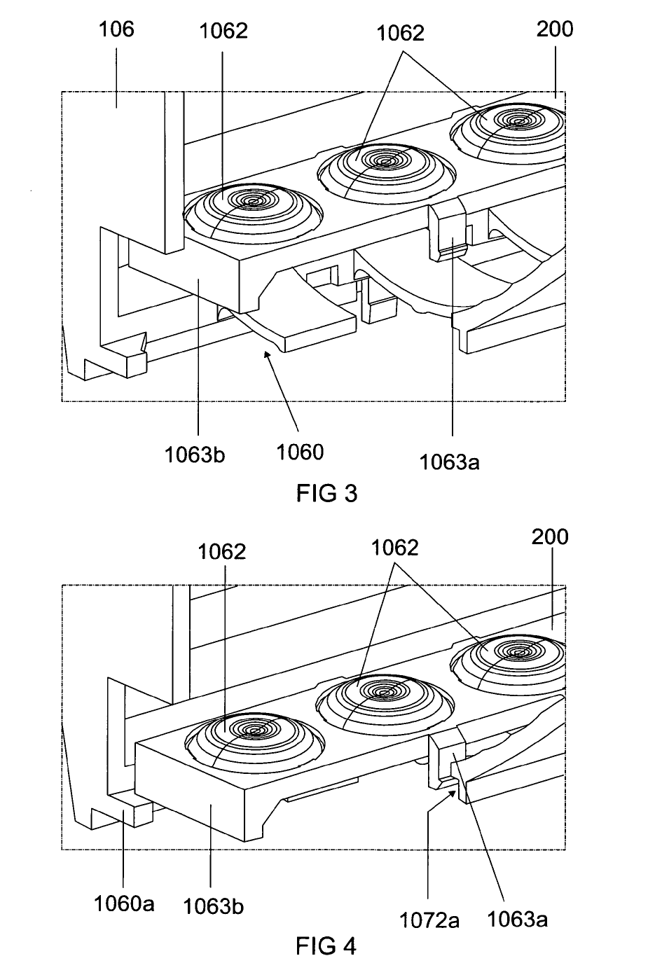

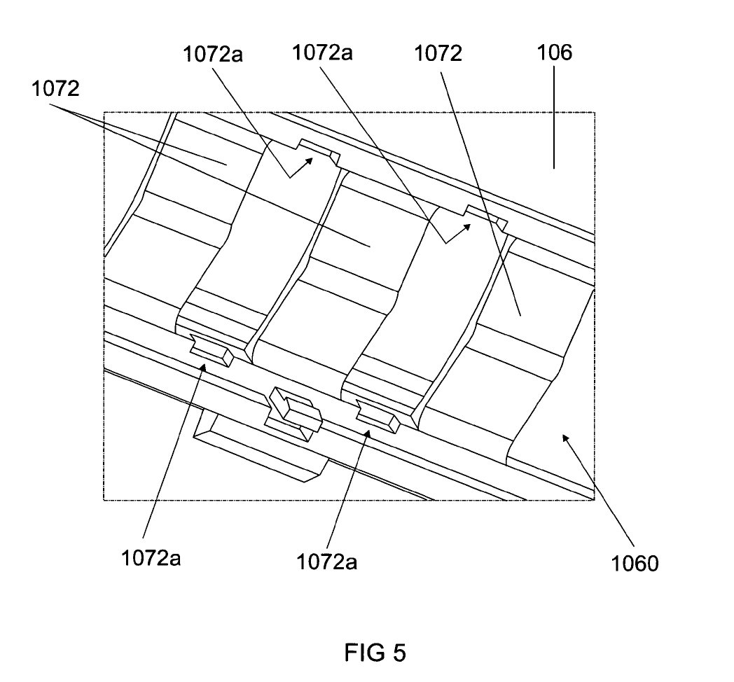

FIGS. 3 and 4 detail the steps of mounting the parts of FIG. 2 in the embodiment of FIG. 1;

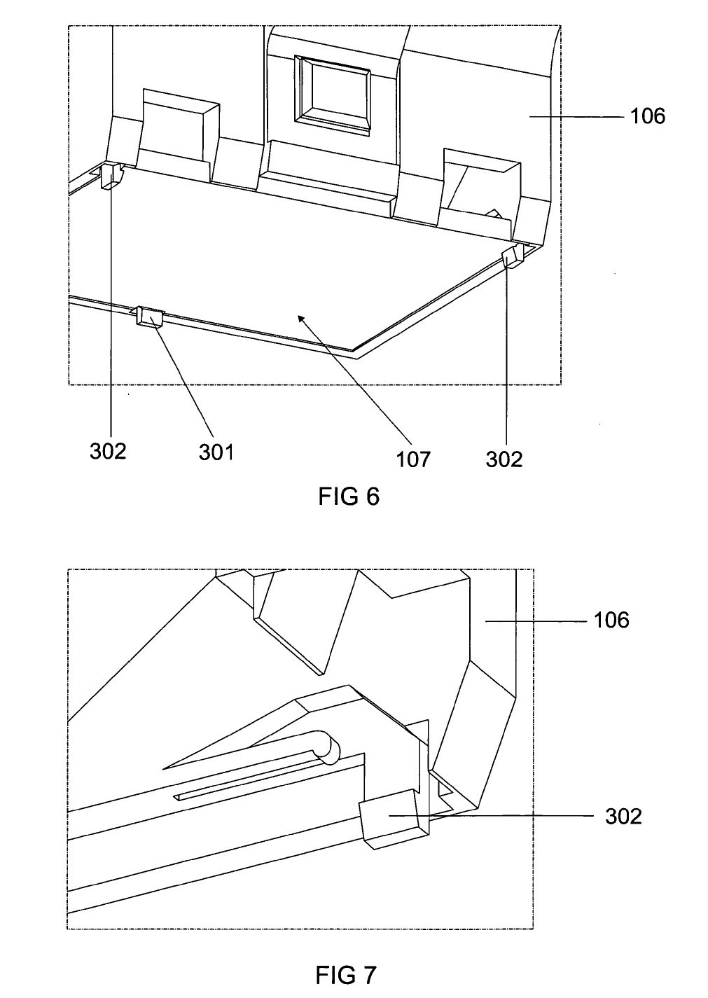

FIGS. 5 to 7 are representative of details of the embodiment of FIG. 1; and

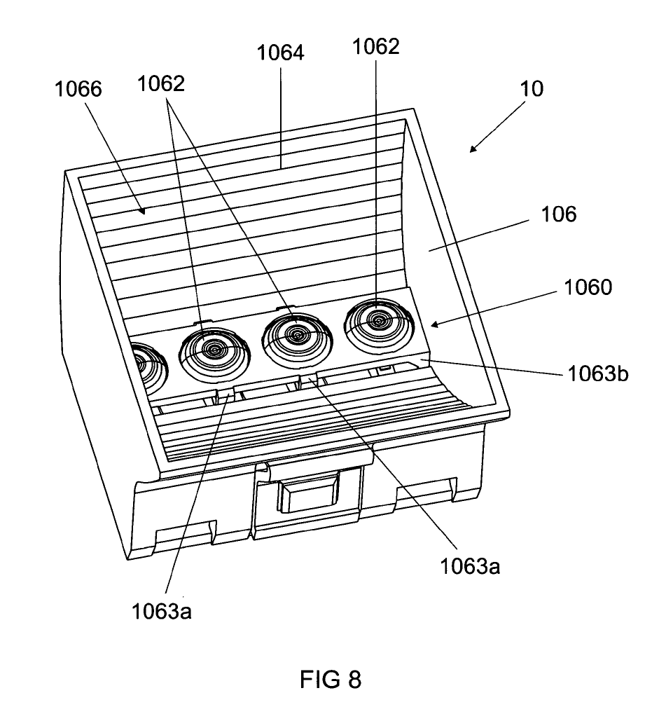

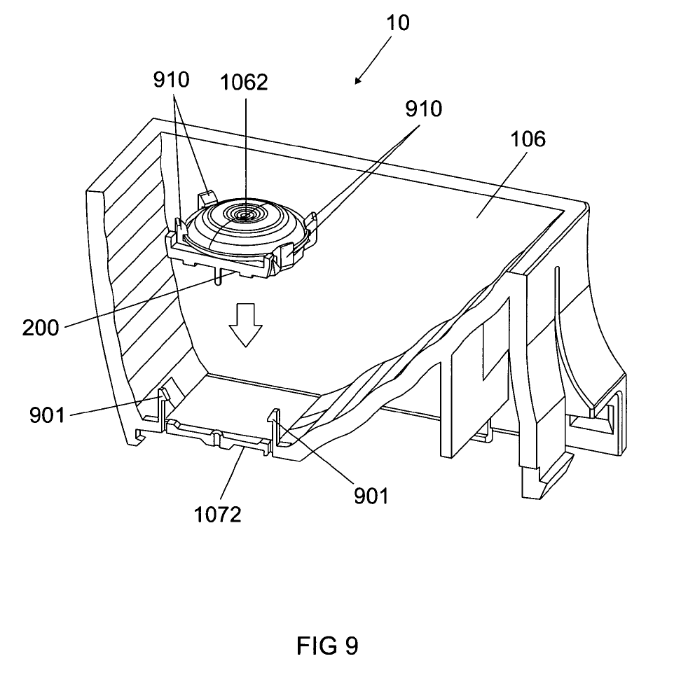

FIG. 8 is a perspective view of the module of FIG. 1 once assembled.

FIG. 9 is an exploded partial view of a lighting module as described herein;

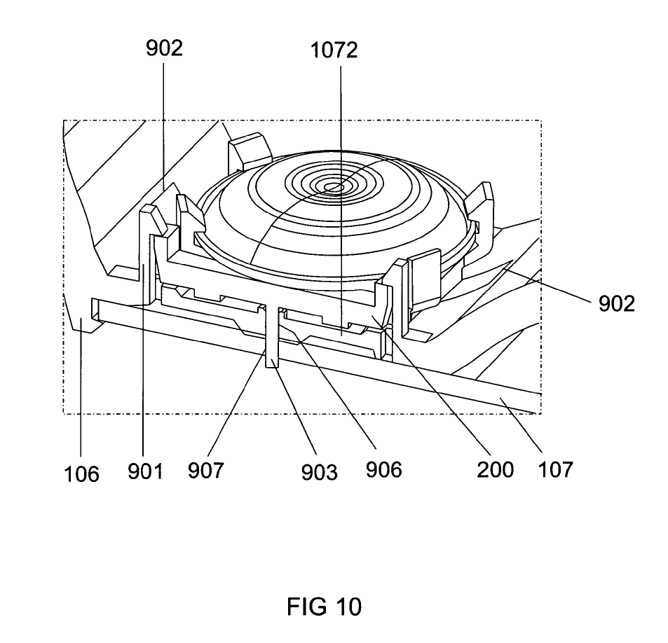

FIG. 10 details certain parts of the embodiment of FIG. 9;

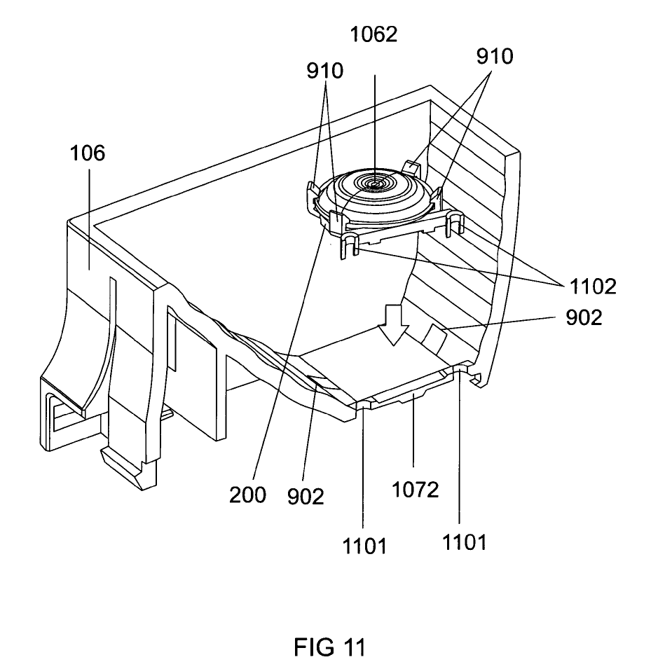

FIG. 11 is an exploded partial view of a lighting module as described herein;

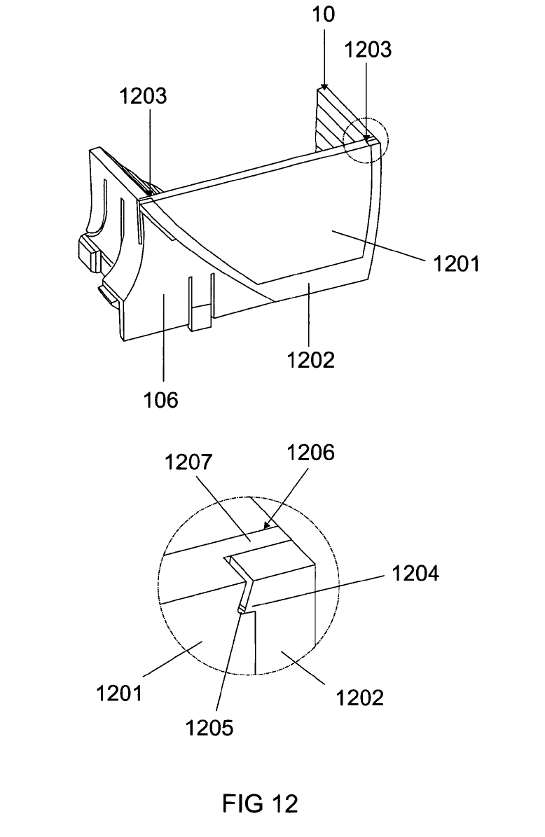

FIG. 12 is a perspective view of a lighting module;

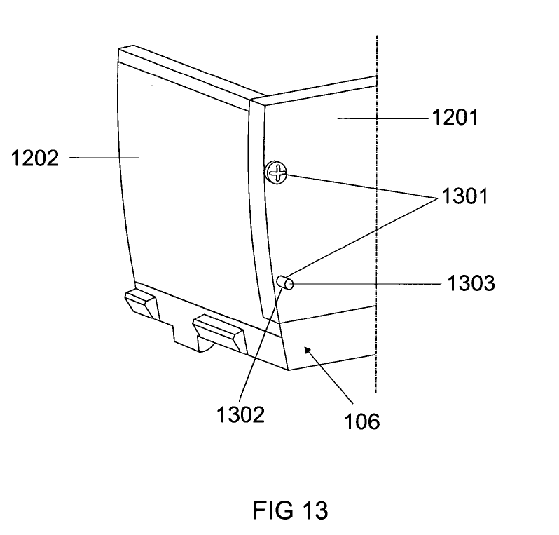

FIG. 13 is a perspective view of a lighting module;

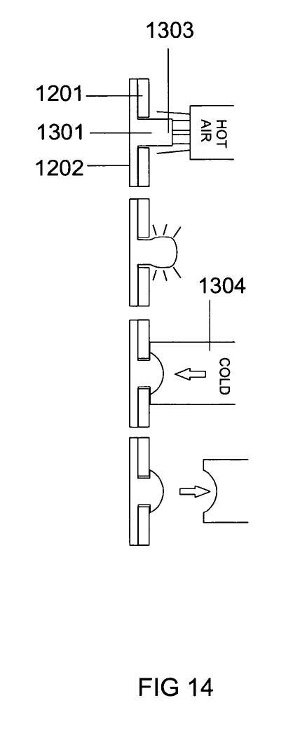

FIG. 14 is a perspective view of a lighting module;

### DETAILED DESCRIPTION OF PREFERRED EMBODIMENTS

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

The embodiment illustrated in the figures is a LED lighting module 10 including one or more LED lighting sources such as high power LED lighting sources L. In the exemplary embodiment considered herein, the module 10 includes a linear array of four LED sources L.

The module 10 is adapted to be mounted (alone or in an array together with other similar modules) on a common support surface by e.g. snap-in coupling with a (e.g. metallic—i.e. heat dissipative) base plate. Electrical connection of the module or modules 10 can be provided via a connector in the form of e.g. a flexible (“flex”) adhesive strip. The module 10 is thus adapted for fast connection to an external support structure (e.g. between some fixed pawls and by using a flexural fastener which allows an easy release of the assembly). Further details of such a mounting arrangement can be found in a parallel application filed on even date by the same applicant.

In the embodiment illustrated, the LED sources L are mounted on a printed circuit board or PCB 107 coupled to a reflector body 106. The PCB 107 carries the LED sources L at its upper side i.e. the side facing the reflector body 106.

As best appreciated in the views of FIGS. 1 and 8, the reflector body 106 is generally vat-shaped with a bottom portion 1060 (see especially FIGS. 3 and 8) provided with apertures for the LED sources L mounted on the PCB 107. Lenses 1062 are associated with the LED sources as better detailed in the following.

The inner surface 1064 of the reflector body 106 is treated to be reflective (by known means, e.g. by being provided with reflective facets) and shaped (e.g. by having an at least approximately parabolic or paraboloid-like shape) to properly direct the light rays from the LED sources L (and especially the “outer” fraction of these light rays possibly escaping the focusing action of the lenses 1062) towards the distal opening 1066 of the reflector body 106 to be projected from the module 10.

The embodiment of module 10 described herein comprise is thus a “light engine” including:
an optical holder 200, namely a holder for the lenses 1062 associated with the LEDs L, which is provided with openings (i.e. lodgings or seats) 1061 for the lenses 1062 as well as with a snap-in system to co-operate with cavities in the reflector body, and
the reflector body 106 with cavities to allow coupling with the optical holder 200 as well as a snap-in/flexural springs system to hold the (e.g. metal core) PCB 107 carrying the LEDs.

As better detailed in the following, the arrangement described herein thus includes first snap-in coupling formations to couple the printed circuit board 107 to the bottom portion 1060 of the reflector body 106 and second snap-in coupling formations to couple the optical holder 200 to the bottom portion 1060 of the reflector body 106.

In the embodiment shown in FIG. 2, the optical holder 200 is a piece of (e.g. transparent) plastics material including a plane rectangular frame having a plurality of openings 1061 therein for receiving the lenses 1062. In an embodiment, the lenses 1062 are circular Argus lenses interference-fitted to (i.e. snapped into) the openings 1061 in the frame of the holder 200.

Leg-like formations 1063a, 1063b extend from the frame of the holder 200. These formations 1063a, 1063b are adapted to cooperate with the reflector body 106 as better detailed in the following. In an embodiment, these formations 1063a, 1063b are integrally moulded parts of the holder 200.

In the embodiment shown, the formations 1063a, 1063b in the holder 200 include:
a first set of formations 1063a arranged at an intermediate position of the holder frame (e.g. in correspondence with the two “inner” holes 1061) and having hook-like distal ends that extend outwardly of the holder 200; and
a second set of formations 1063b provided at the ends of the holder frame.

FIGS. 3 and 4 are representative of an intermediate sequence of steps in assembling the module 10.

In FIG. 3 the holder 200 having the lenses 1062 mounted in the openings 1061 is advanced (i.e. lowered) into the bottom portion 1060 of the reflector body 106. This movement causes the formations 1063a to enter openings provided in the bottom portion 1060. In the embodiment shown (see especially FIG. 5, which is a “bottom” view of the portion 1060 of the reflector body 106), these openings are substantially rectangular openings formed between bridge-like formations 1072 which are solidary or integral with the reflector body 106.

FIG. 4 shows the holder 200 further advanced into the bottom portion 1060 of the reflector body 106 down to a point where:
the formations 1063b provided at the ends of the holder 200 abut against at least one step-like formation 1060a extending from the wall of the bottom portion 1060 of the reflector body 106; and
the formations 1063a engage in a hook-like manner the wall of the bottom portion reflector body 106 at cavities 1072a (see FIG. 5) intermediate the bridge-like formations 1072. This snap-in engagement action is permitted by the elastic behaviour of the material comprising the holder 200.

The holder 200 (and the lenses 1062 carried thereby) are thus securely and precisely mounted onto the reflector body 106 to provide their focusing action on the light radiation emitted by the LEDs L.

The primary optical system comprised of the holder 200 and the lenses 1062 is thus both easy to mount and to replace. Costs are correspondingly reduced while guaranteeing a high quality in the lenses 1062.

The metal core PCB 107 can be mounted by a simple manual placement into the lower opening of the reflector body 106 and fixed thereto by means of e.g. three snap-in formations 301, 302.

In the exemplary embodiment shown, reference 301 denotes a hook-like formation extending from the reflector body 106 to engage a notch 107a (see FIG. 1) provided centrally in the longitudinal side of the PCB 107 proximate to the LEDs. References 302 denotes two hook-like, elastically resilient formations extending from the reflector body 106 to engage notches 107b (see again FIG. 1) provided at the transversal sides of the PCB 107 in a near-angular position to the PCB opposite the LEDs. The resilient behavior of the formations 302 (and possibly 301) allows for tolerances in the PCB thickness.

FIG. 9 shows another embodiment of the invention in an exploded partial view of a lighting module 10. A holder 200 equipped with a lens 1062 is to be fixed to the reflector body 106. The lens 1062 is held by four snap-in connectors 910.

A bridge-like formation 1072 connects the opposite sidewalls 902 of the reflector 106, bearing two hook-like structures 901.

As shown in FIG. 10, these hook-like structures 901 are used as snap-in connectors 901 to fix the holder 200 to the reflector 106, the formation 1072 being used as a rest for the holder 200. The holder 200 also rests against the sidewalls 902 of the reflector 106, both parts being shaped in a suitable manner.

On the lower side of the holder 200 a pin 903 protrudes which is used as a positioning device of the holder 200 as well as the reflector 106 with respect to each other as well as with respect to the PCB 107 by fitting the pin 903 into corresponding holes 906, 907 in the reflector 106 and the PCB 107, respectively.

Unlike in the previous embodiments in this embodiment the reflector 106 is equipped with the hook-like structures 901 to hold the holder 200. The holder 200 may be designed to hold several lenses 1062, most easily by simply repeating the shown structure periodically, but it might also be useful to have a separate holder 200 for every single lens 1062.

FIG. 11 is a general exploded view of a lighting module 10 similar to that of FIG. 9. The holder 200 equipped with a lens 1062 is to be fixed to the reflector body 106. The lens 1062 is held by four snap-in connectors 910.

A bridge-like formation 1072 connects the opposite sides 902 of the reflector 106. Two holes 1101 are placed in the reflector 106 which correspond to two ring-type snap-in connectors 1102. The holder 200 is being mounted by inserting the snap-in connectors 1102 into the holes 1101 and also into corresponding holes in a PCB 107 which are not shown here. Positioning of the lens holder 200 with respect to the reflector 106 and to the PCB 107 is ensured by the suitable tolerances of the snap-in connectors 1102, of the holes 1101 in the reflector 106, and of the holes in the PCB 107. If high precision is needed it is also possible to add a pin 903 and suitable holes 906, 907 as shown in the previous embodiment.

FIG. 12 is a perspective view of a lighting module 10 (left) and a detailed view of a snap-fit connection on the module (right). The reflector 106 comprises a sidewall 1201 and a reflector body 1202. The sidewall 1201 is fixed to the reflector body 1202 by two snap-fit connections 1203 of which one is shown in detail on the right of FIG. 12.

The reflector body 1202 has a snap-in hook 1204 on its outer end which fits into a snap-in groove 1205 in the sidewall 1201. Next to the snap-in hook 1204 is a notch 1206 which holds a dent 1207 of the sidewall 1201 thereby preventing the side wall 1201 from sidewards movement. An additional tongue and groove joint may be additionally provided on the lower part of the sidewall 1201 for this purpose.

The sidewall 1201 is mounted by a downward movement thereby entering the snap-in connections 1203. The embodiment offers particularly easy assembling as well as a simple construction that can be manufactured with little effort.

Another embodiment is shown in FIG. 13, where the end part of a reflector 106 is shown which is partially assembled. The reflector body 1202 has got two pins 1301 that fit into holes 1302 of the sidewall 1201. As shown in FIG. 14 after mounting the sidewall 1201 to the reflector 106 by inserting the pins 1301 into the holes 1302, the head 1304 of each pin 1301 is deformed by thermoplastic staking, i.e. heating up the head 1304 of the pin 1301, for example by hot air or other suitable means like laser beam or infrared radiation, then applying a cold stamp 1304 deforming the head 1303 of the pin 1301 and then removing the stamp 1304. By this procedure the sidewall 1201 is securely fitted to the reflector body 1202.

The material of the sidewall 1201 is chosen to keep its mechanical strength at higher temperatures than the material of the reflector body 1202 in order to avoid deformation of the sidewall 1201 when the pin 1301 is deformed. This can either be realized by using plastics with different melting points for the reflector body 1202 and the sidewall 1201 or by using a reflector body 1202 made of plastics and a sidewall 1201 made of a suitable metal like aluminum, brass or steel.

This embodiment offers high accuracy i.e. low dimensional tolerances and a very secure and sturdy connection.

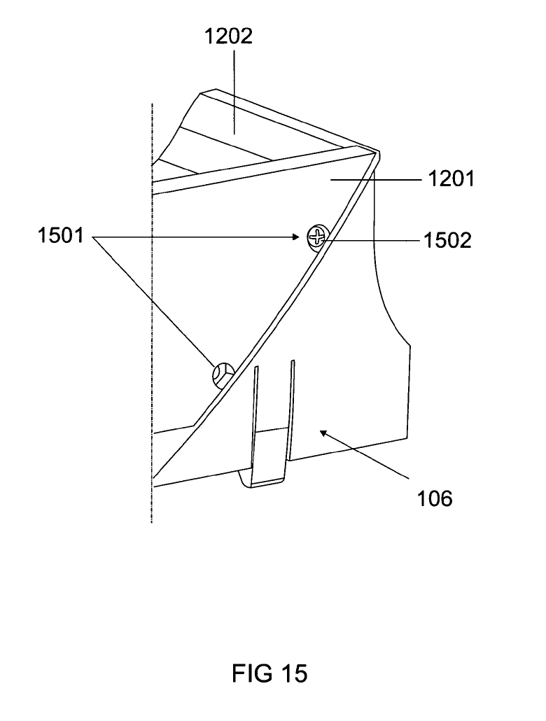

A further embodiment is shown in FIG. 15 where the reflector 106 with a reflector body 1202 and a sidewall 1201 is partially shown. The sidewall 1201 is provided with two stepped holes 1501. These holes 1501 are used to fix the sidewall 1201 to the reflector body 1202 by screws 1502. For ease of understanding only the upper screw 1502 is shown. In this embodiment self-tapping screws 1502 are used which makes it easy to mount the sidewall 1201 to the reflector body 1202 which is preferably made of plastics. In order to make the exact placement of the sidewall 1201 easier it is favourable to have small holes in the reflector body 1202 to guide the self-tapping screws 1502. The holes may also have other suitable shapes, especially conical or simple passage-holes. Reflectors 106 according to this embodiment can easily be assembled without expensive equipment and exhibit low dimensional tolerances.

Without prejudice to the underlying principles of the invention, the details and the embodiments may vary, even appreciably, with respect to what has been described by way of example only, without departing from the scope of the invention as defined by the annexed claims.

1. A lighting module, comprising:
a printed circuit board carrying at least one light source,
a reflector body to direct light from said at least one light source towards a distal opening of said reflector body, said reflector body having a bottom portion with first snap-in coupling formations coupling said printed circuit board to the bottom portion of said reflector body, and
flan optical holder carrying at least one lens to focus light from said at least one light source, said optical holder having second snap-in coupling formations coupling said optical holder to the bottom portion of said reflector body.

2. The lighting module of claim 1,
wherein said optical holder includes a frame having at least one opening therein for receiving said at least one lens.

3. The lighting module of claim 2,
wherein said at least one lens is interference-fitted into said at least one opening in said frame of the holder.

4. The lighting module of claim 1,
wherein said optical holder includes leglike formations providing said second snap-in coupling formations to couple said optical holder to the bottom portion of said reflector body.

5. The lighting module of claim 4,
wherein said leg-like formations include hook-like distal ends to engage with said bottom portion of said reflector body.

6. The lighting module of claim 4,
wherein said bottom portion of said reflector body includes cavities for engagement by said leg-like formations.

7. The lighting module of claim 1,
wherein said optical holder includes at least one abutment formation to abut against said bottom portion of said reflector body.

8. The lighting module of claim 7,
wherein said bottom portion of said reflector body includes at least one step-like formation for abutment by said at least one abutment formation of said optical holder.

9. The lighting module of claim 1,
wherein said printed circuit board is a metal core printed circuit board.

10. The lighting module of claim 1,
wherein said first snap-in coupling formations to couple said printed circuit board to the bottom portion of said reflector body includes hook-like formations extending from said reflector body.

11. The lighting module of claim 1,
wherein said first snap-in coupling formations include:
an individual coupling formation to engage one side of said printed circuit board,
paired coupling formations to engage said printed circuit board at near-angular positions to the printed circuit board opposite said one side.

12. The lighting module of claim 1, further comprising:
a plurality of light sources carried by said printed circuit board and a corresponding plurality of lenses carried by said optical holder.

13. The lighting module of claim 1,
wherein said at least one light source comprises a light emitting diode.

14. The lighting module of claim 1,
wherein at least one sidewall of the reflector is mounted to a reflector body by form-locking means.

15. A method of assembling a lighting module, the method comprising:
providing a printed circuit board carrying at least one light source,
coupling said printed circuit board to a reflector body to direct light from said at least one light source towards a distal opening of said reflector body, wherein said coupling is via first snap-in coupling formations coupling said printed circuit board to a bottom portion of said reflector body,
providing an optical holder carrying at least one lens to focus light from said at least one light source, coupling said optical holder to said reflector body wherein said coupling is via second snap-in coupling formations coupling said optical holder to the bottom portion of said reflector body.

16. The lighting module of claim 14,
wherein the form-locking means comprises at least one of a snap-in coupling; a thermoplastic staking; and a screw joint.
